(19) United States
(12) Patent Application Publication
(10) Pub. No.: US 2014/0360387 A1
(43) Pub. Date: Dec. 11, 2014

(54) COOL TEMPERATURE SMOKER

(71) Applicant: Jon Eric Bogdon, Trimble, MO (US)

(72) Inventor: Jon Eric Bogdon, Trimble, MO (US)

(21) Appl. No.: 14/301,749

(22) Filed: Jun. 11, 2014

Related U.S. Application Data
(60) Provisional application No. 61/833,801, filed on Jun. 11, 2013.

(51) Int. Cl. A23B 4/052

(52) U.S. Cl. CPC A23B 4/0523
USPC 99/476

(57) ABSTRACT

A cool temperature smoker includes a housing, an external smoke box, a duct, and a fan. The smoke box produces wood smoke at a temperature above ambient temperature, with the smoke box being positioned outside the food chamber. The duct extends between and fluidly connects the smoke box and the food chamber to one another along a duct path, with the duct being operable to fluidly transmit wood smoke along the duct path. The fan is positioned in fluid communication with the duct and is operable to provide a controlled flow of wood smoke through the duct. The duct extends at least partly outside the food chamber and is configured to be exposed to ambient conditions along the duct path to dissipate heat from the controlled flow of wood smoke as the wood smoke travels toward and into the food chamber.

### RELATED APPLICATION

This application claims the benefit of U.S. Provisional Application Ser. No. 61/833,801, filed Jun. 11, 2013, entitled AMBIENT SMOKER, which is hereby incorporated in its entirety by reference herein.

### BACKGROUND

1. Field

The present invention relates generally to food cooking and smoking equipment. More specifically, embodiments of the present invention concern a smoker and a smoke delivery assembly operable to smoke food and selectively operable as a cool temperature smoker.

2. Discussion of Prior Art

Various types of conventional cooking appliances and equipment are employed to smoke food. For instance, there are many types of powered food cooking enclosures, such as an outdoor barbeque grill, that are capable of receiving wood smoking chunks and/or chips to cook and smoke meat (such as beef, pork, etc.). It is also known in the art to use a smoker to smoke food at relatively low cooking temperatures.

However, prior art cooking appliances and smokers have certain deficiencies. For instance, such conventional appliances generally cook the food that is being smoked. For some foods that are intended to be smoked, such as cheeses, cooking may be unnecessary or undesirable. Even where the appliance does not use a heating source directly below the food to produce wood smoke (i.e., where the smoker uses an indirect source of heat to produce wood smoke), the resulting wood smoke still tends to cook the food.

### SUMMARY

The following brief summary is provided to indicate the nature of the subject matter disclosed herein. While certain aspects of the present invention are described below, the summary is not intended to limit the scope of the present invention.

Embodiments of the present invention provide a smoker and a smoke delivery assembly that do not suffer from the problems and limitations of the prior art appliances set forth above.

A first aspect of the present invention concerns a cool temperature smoker operable to marinate food in natural smoke. The cool temperature smoker broadly includes a housing, an external smoke box, a duct, and a fan. The housing defines a food chamber to receive the food during smoking. The external smoke box produces wood smoke at a temperature above ambient, with the smoke box being positioned outside the food chamber. The duct extends between and fluidly connects the smoke box and the food chamber to one another along a duct path, with the duct being operable to fluidly transmit wood smoke along the duct path. The fan is positioned in fluid communication with the duct and is operable to provide a controlled flow of wood smoke through the duct. The duct extends at least partly outside the food chamber and is configured to be exposed to ambient conditions along the duct path to dissipate heat from the controlled flow of wood smoke as the wood smoke travels toward and into the food chamber.

A second aspect of the present invention concerns a smoke delivery assembly operably connectable to a cooking enclosure to marinate food in natural smoke, with the cooking enclosure defining a food chamber to receive the food during smoking. The smoke delivery assembly broadly includes an external smoke box, a duct, and a fan. The external smoke box produces wood smoke at a temperature above ambient temperature, with the smoke box operable to be positioned outside the food chamber. The duct is fluidly connected to the smoke box and is operable to extend between and fluidly connect the smoke box and the food chamber to one another along a duct path, with the duct being operable to fluidly transmit wood smoke along the duct path. The fan is positioned in fluid communication with the duct and is operable to provide a controlled flow of wood smoke through the duct. The duct is operable to extend at least partly outside the food chamber and to be exposed to ambient conditions along the duct path to dissipate heat from the controlled flow of wood smoke as the wood smoke travels toward and into the food chamber.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a front perspective of a cool temperature smoker constructed in accordance with a preferred embodiment of the present invention, with the smoker including a housing, a lid, a control panel, and a smoke delivery assembly;

FIG. 2 is a fragmentary front perspective of the cool temperature smoker shown in FIG. 1, showing a slide plate of an ash receiving assembly moved to an open position to release ash and/or wood particles into a holding bin;

FIG. 3 is a fragmentary front perspective of the cool temperature smoker shown in FIGS. 1 and 2, showing the smoker sectioned along a longitudinal axis thereof to depict a smoke generating assembly and a diffuser of the smoke delivery assembly, and further depicting food racks positioned above an internal heating element and within a food chamber of the smoker;

FIG. 4 is a fragmentary front perspective of the cool temperature smoker similar to FIG. 3, but showing a cross section taken along a line rearwardly from that of FIG. 3 to depict a fan and the diffuser of the smoke delivery assembly;

FIG. 5 is a front elevation of the smoker shown in FIGS. 1-3;

FIG. 6 is a front elevation of the smoker shown in FIGS. 1-3;

FIG. 7 is a cross section of the smoker taken along line 7-7 in FIG. 6, showing an exterior smoker heating element of the smoke generating assembly;

FIG. 8 is across section of the smoker taken along line 8-8 in FIG. 6;

FIG. 9 is a top view of the smoker shown in FIGS. 1-8;

FIG. 10 is a right side elevation of the smoker shown in FIGS. 1-9;

FIG. 11 is a rear elevation of the smoker shown in FIGS. 1-10;

FIG. 12 is a left side elevation of the smoker shown in FIGS. 1-11;

FIG. 13 is a fragmentary perspective of the exterior smoker heating element shown in FIGS. 3 and 7, showing an elongated insulator of the heating element;

FIG. 14 is a perspective of the elongated insulator similar to FIG. 13, but viewed from the opposite direction;

FIG. 15 is an enlarged fragmentary perspective of the elongated insulator shown in FIGS. 13 and 14;

FIG. 16 is a side elevation of the elongated insulator shown in FIGS. 13-15;

FIG. 17 is a top view of the elongated insulator shown in FIGS. 13-16, showing a helical path along which an electrical resistance wire can be mounted on the insulator;

FIG. 18 is a cross section of the elongated insulator taken along line 18-18 in FIG. 17;

FIG. 19 is a front elevation of the elongated insulator shown in FIGS. 13-18;

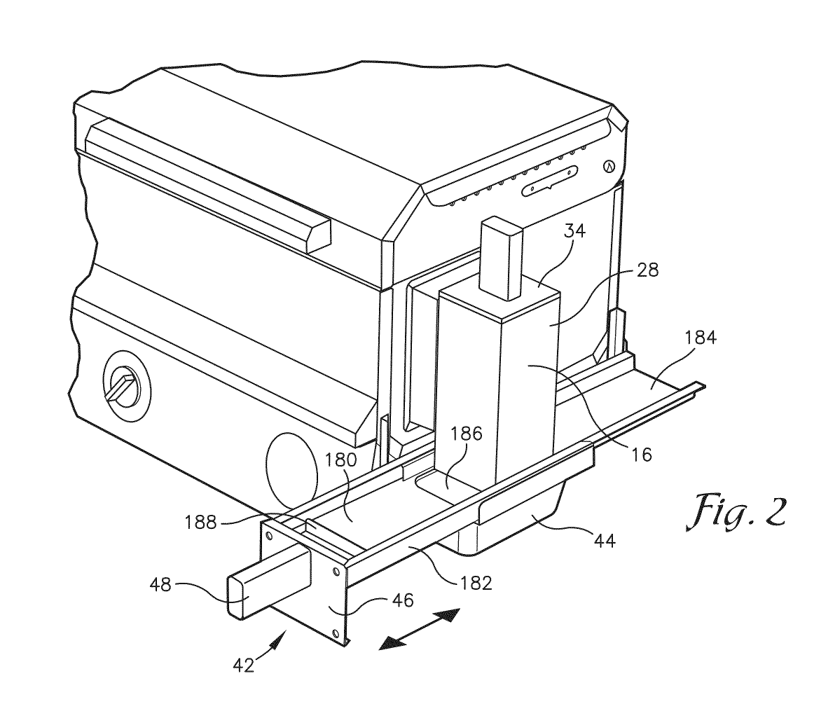

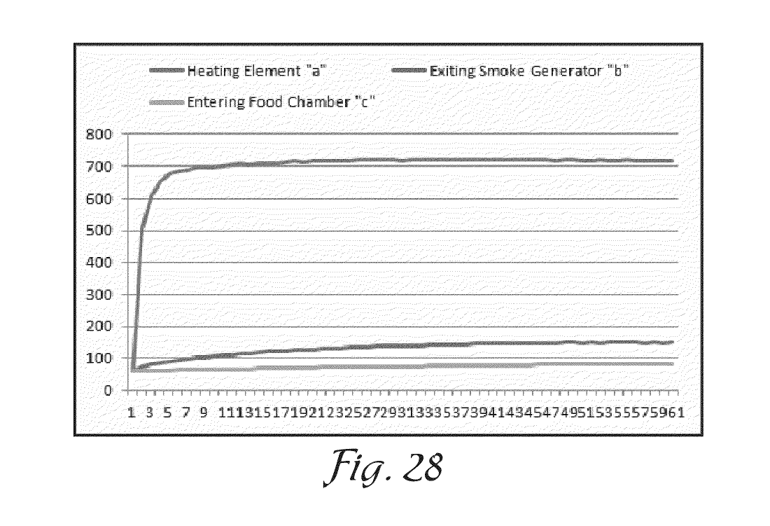

FIG.2.0 is a cross section of the elongated insulator taken along line 20-20 in FIG. 19;

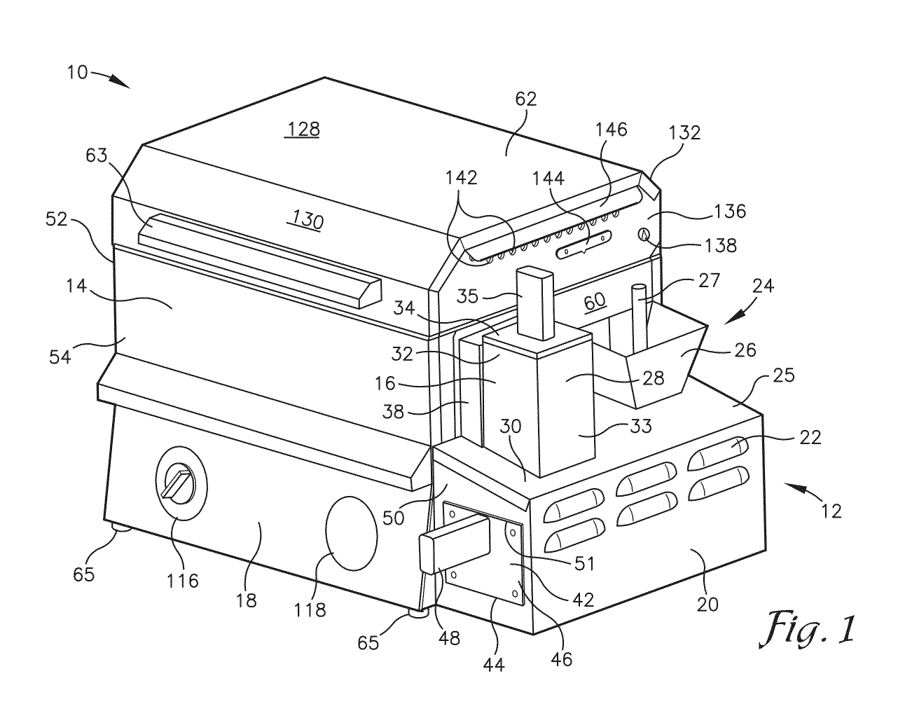

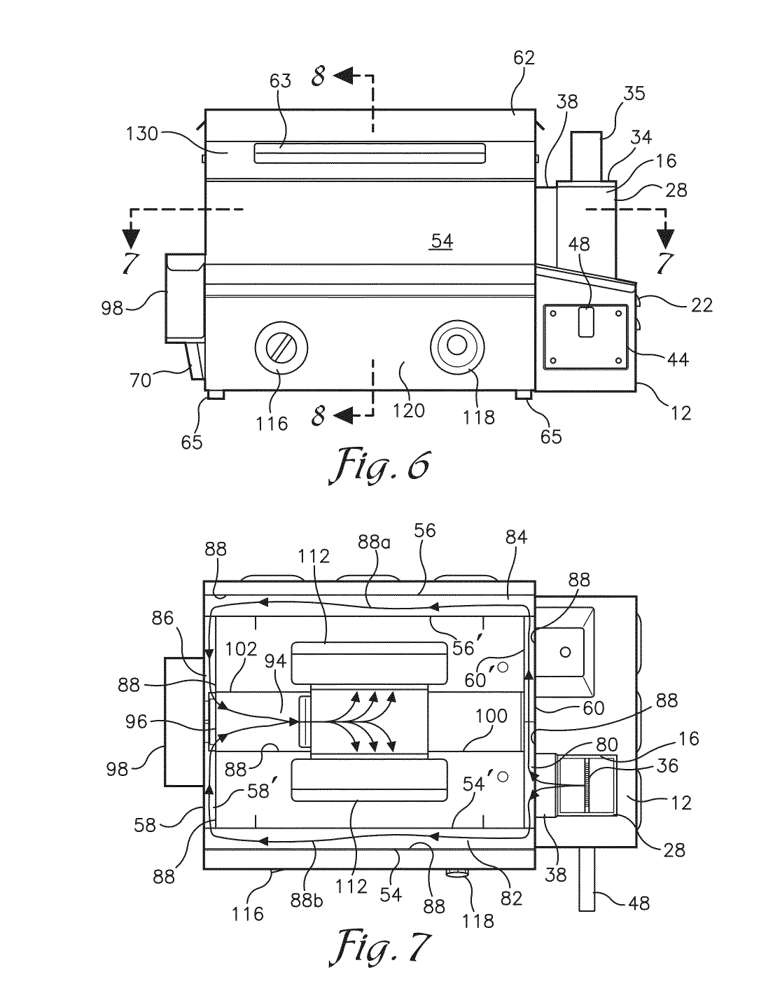

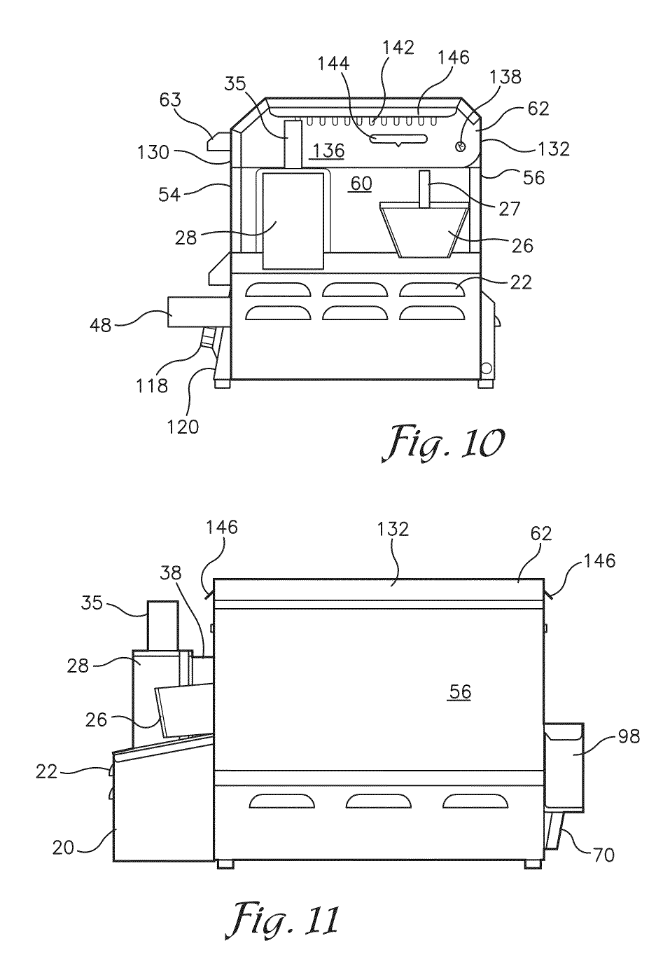

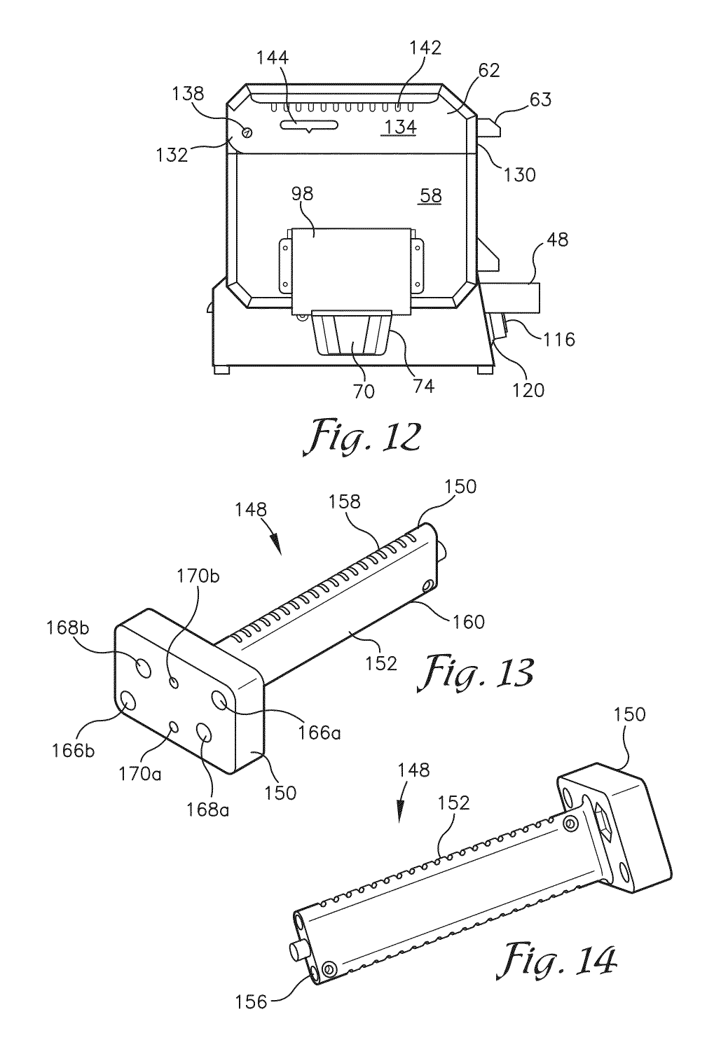

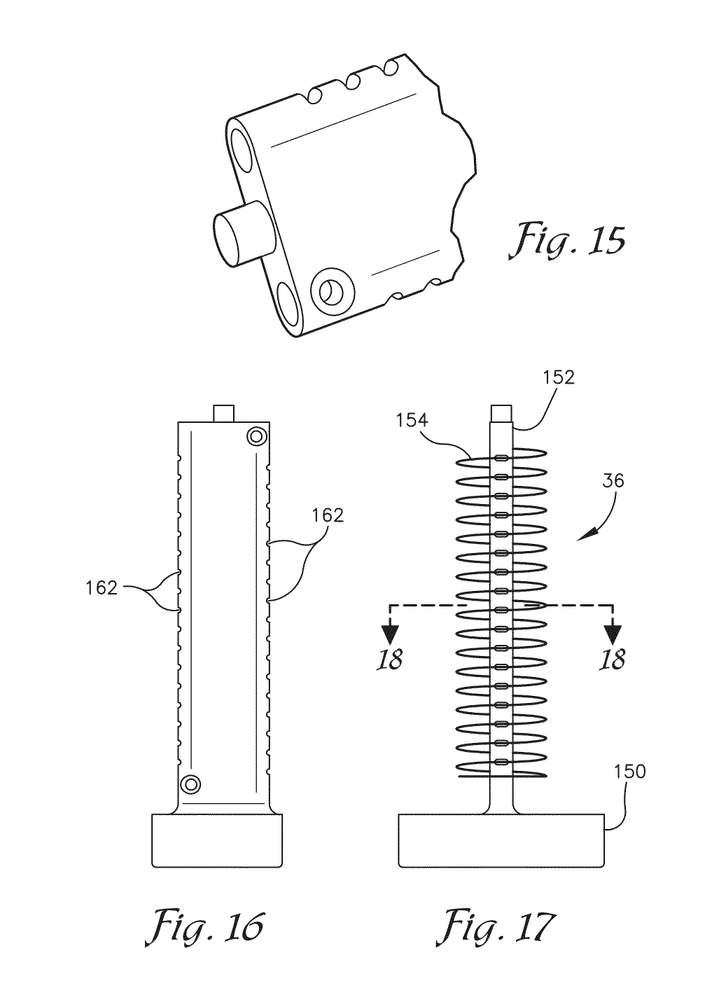

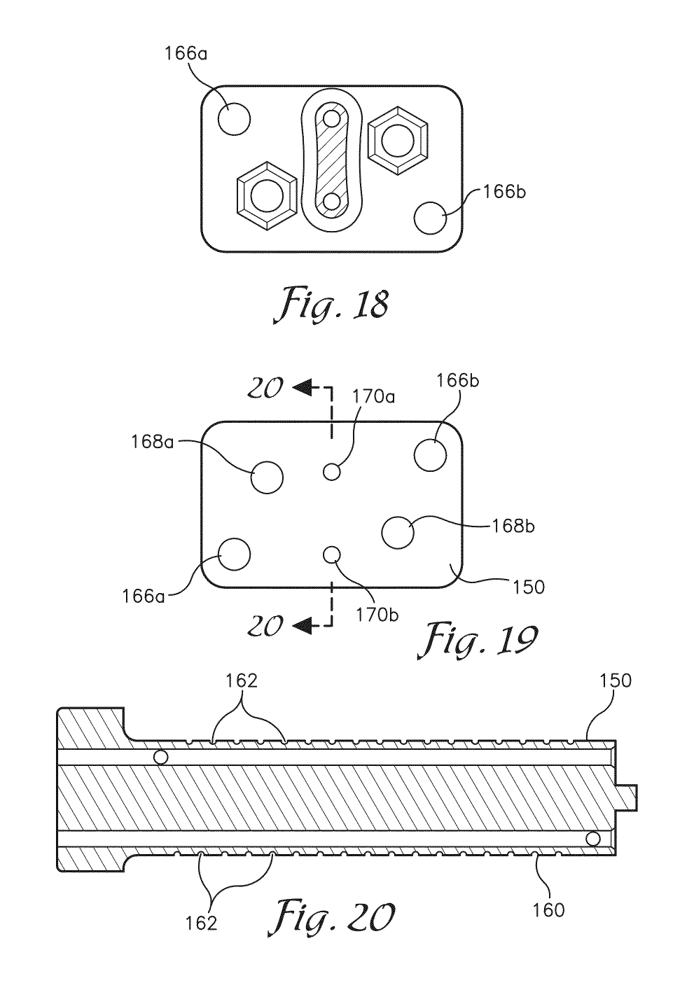

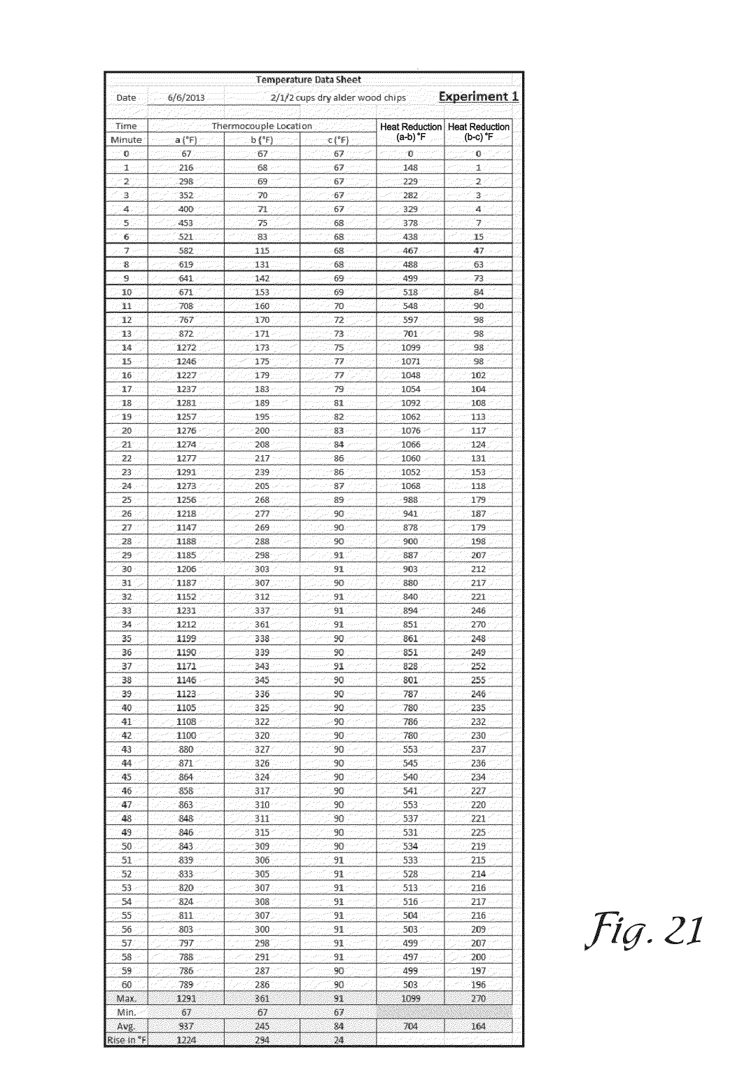

FIG. 21 is a table of experimental temperature data taken while operating the smoke delivery assembly of the smoker shown in FIGS. 1-12, with two and one half cups of dry alder wood chips being used in the smoke generating assembly during the experiment, and with the data being identified as Experiment 1;

FIG. 22 is a line plot of the experimental data shown in FIG. 21;

FIG. 23 is a table of experimental temperature data taken while operating the smoke delivery assembly of the smoker shown in FIGS. 1-12, with two and one half cups of dry alder wood chips being used in the smoke generating assembly during the experiment, and with the data identified as Experiment 2;

FIG. 24 is a line plot of the experimental data shown in FIG. 23;

FIG. 25 is a table of experimental temperature data taken while operating the smoke delivery assembly of the smoker shown in FIGS. 1-12, with no wood chips being used in the smoke generating assembly during the experiment, and with the data identified as Experiment A;

FIG. 26 is a line plot of the experimental data shown in FIG. 25;

FIG. 27 is a table of experimental temperature data taken while operating the smoke delivery assembly of the smoker shown in FIGS. 1-12, with no wood chips being used in the smoke generating assembly during the experiment, and with the data identified as Experiment B; and

FIG. 28 is a line plot of the experimental data shown in FIG. 27.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

Turning initially to FIGS. 1-12, an ambient or cool temperature smoker 10 is provided, and in one embodiment can include a smoke generating assembly 12, a food chamber 14, a smoke delivery assembly 16, and a control panel 18.

The term “ambient” refers to a temperature at, or relatively near, the temperature of the surrounding area or environment. For purposes of this invention, “ambient” temperature encompasses temperatures approximating the temperature of the surrounding area or environment. “Cool” temperature smoking is defined as smoking a food (or other) product at a temperature of approximately 100° F. or less. A “cool temperature smoker” is defined as a smoker that is capable of smoking a food (or other) product at a temperature of approximately 100° F. or less. Such a cool temperature smoker may also be capable of smoking a food (or other) product at a temperature of greater than approximately 100° F. (e.g., where the smoker includes an internal heating element to provide such an elevated temperature).

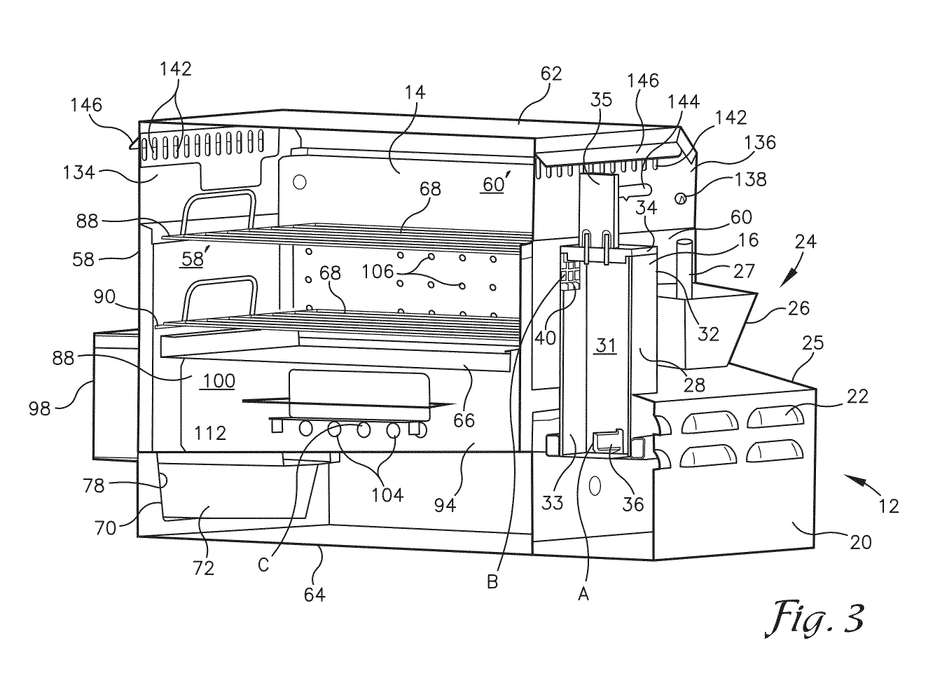

In one embodiment, smoke generating assembly 12 comprises a smoke box that can include a smoke generator housing 20 which can have a plurality of air vents 22 therein. An elongated generally vertical smoke generating chamber 28 can extend upwardly from housing 20, adjacent a front portion 30 of smoke generator housing 20, and can be composed of a four-sided square tube or can be a circular cylinder in structure. In one embodiment, smoke generating chamber is a four-sided square tube. A slot can be provided in the upper portion 32 of the chamber 28 for connection to air flow portal 40. The chamber 28 may also include a series of uppermost tabs (not shown) spaced about the upper portion 32 of the chamber 28. The smoke generating assembly 12 can further include an external smoker heating element 36 that can be positioned adjacent lower end portion 33, and can provide the heat source which is applied to the wood to generate the smoke for smoker 10. Heating element 36 (see FIG. 3) can preferably be an electrical resistance heating element. Smoke generating chamber 28 can also have a lid 34 covering the top portion 32 thereof, the lower end portion 33 essentially closed off by the wood/ash receiving base 180 included into the slide plate 182 (see FIG. 2). Lid 34 can include a handle 35, wherein the lid 34 can be removed for allowing access to chamber 28, when desired for filling chamber with wood or other purposes. The lid 34 can be supported by the uppermost tabs. The tabs operate such that any creosote build-up along the lid 34 does not prevent removal of the lid 34 from the upper portion 32. A wood source such as wood chips or the like (not depicted) can be introduced through removable funnel 26 and into smoke generating chamber 28.

In the illustrated embodiment, the smoke generating assembly 12 is preferably positioned outside the food chamber 14 and adjacent one end of the food chamber 14, although the smoke generating assembly 12 could be alternatively positioned relative to food chamber 14.

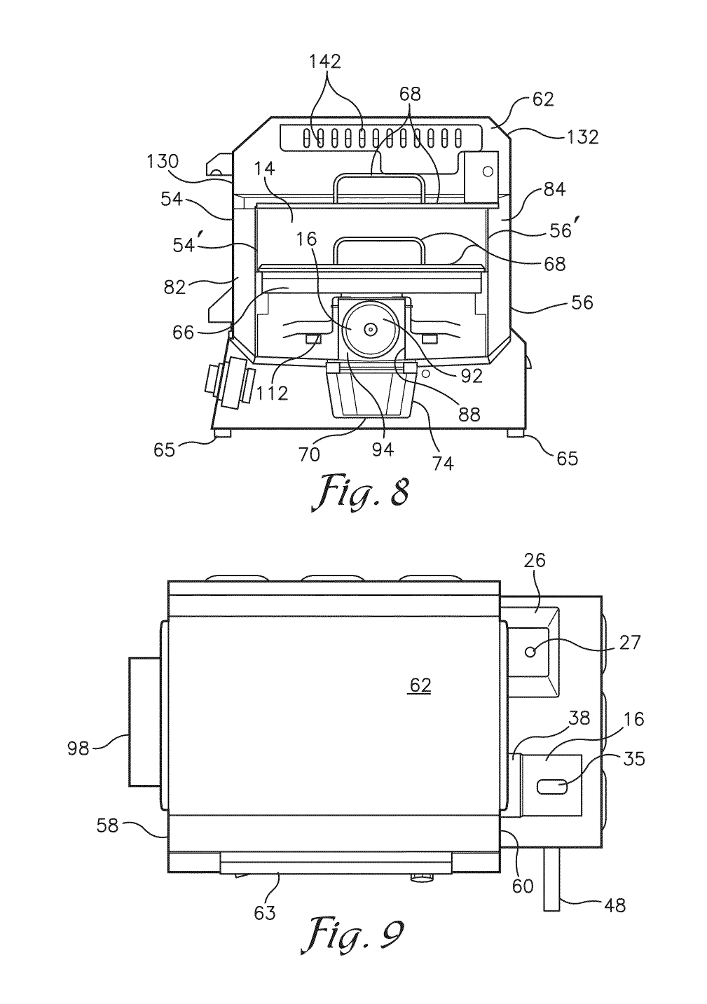

In one embodiment, a smoke plenum 38 can be provided between the smoke generator chamber 28 and the food chamber 14. An air flow portal 40 can be provided adjacent upper end portion 32 of chamber 28, providing fluid communication between smoke generator chamber 28 and smoke plenum 38. In addition, an opening in the right wall 60 of the smoker primary housing 52 can be provided adjacent to a lower portion of plenum to provide fluid communication between smoke plenum and right smoke chamber 80 (see FIG. 7). An ash receiving assembly 42 can be situated beneath heating element 36, and can be provided to receive wood and retain ash which is generated by contact between the electric heating element 36 and a wood source introduced into the smoke generator chamber 28 during operation of the smoker 10, as will be described in detail below. In another embodiment, no smoke plenum is provided and the smoke exits the smoke generator chamber 28 and directly enters the right smoke chamber 80.

Ash receiving assembly 42 can include a slide plate rail support 184 (see FIG. 2) which is directly mounted to smoke chamber 28, and remains stationary. A horizontal slide plate 182 can selectively move horizontally to an open or a closed position (in and out) in conjunction with the slide plate rails 184. The horizontal slide plate 182 can include a wood/ash receiving base 180 which is located directly under smoke chamber 28 and wood heating element 36 when in a closed position, allowing wood and ash to stay captive within smoke chamber 28, until being pulled horizontally to the open position. The bottom of smoke chamber 28 includes an ash port 186, thus allowing used ashes and wood particles to fall into holding bin 44 where the slide plate 182 is in the open position. Slide plate 182 can be completely removed for ash and wood particle disposal or other purposes. Holding bin 44 can include an outer bin wall 46 and a handle 48 extending outwardly from the wall 46. In addition to the physical movement of the horizontal slide plate 182, the smoke generating assembly 12 can include a fixed or variable air gap between the wood/ash receiving base 180 and the bottom of smoke chamber 28, providing controlled combustion air into the smoke chamber 28. A slide plate stop/air diffuser 188 provides a physical stop for the slide plate 182 and an air diffuser to block air currents in windy conditions. Smoke generator housing 20 can include a front side 50 adjacent front portion 30, front side 50 having an opening 51 therein through which at least a portion of ash receiving assembly 42 can pass. When in the closed position, outer bin wall 46 can effectively cover and form a seal around opening 51. Alternatively, ash receiving assembly 42 can be fully removed from the smoke generator housing 20 in order to empty any ash generated by the smoking process which may be contained therein.

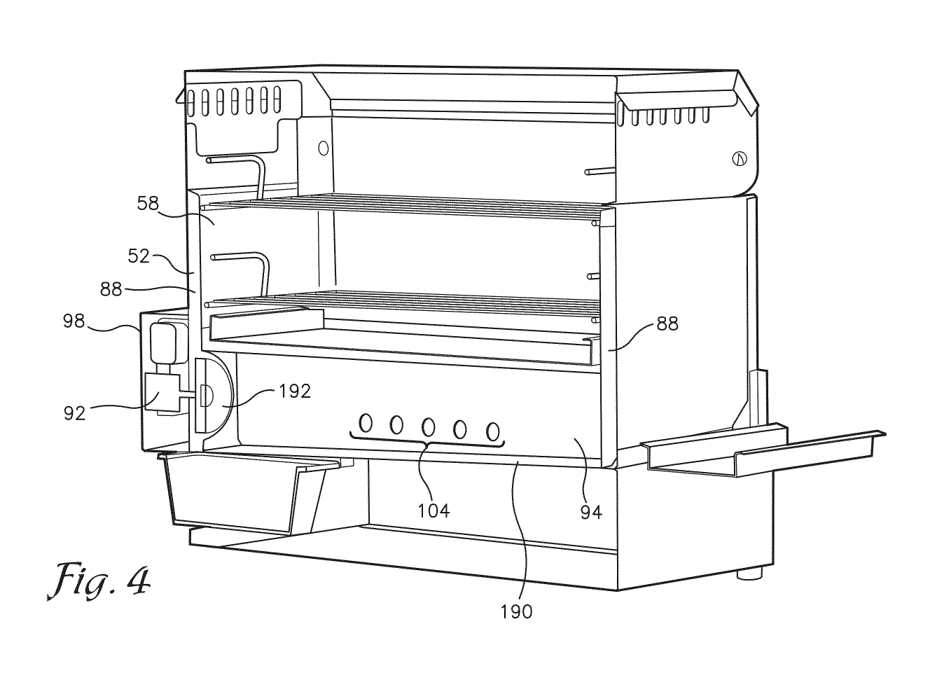

Smoker 10 can include a primary housing 52 (see, e.g., FIG. 4), which can be of any desired shape. In one embodiment, housing 52 can be an essentially open structure having a square or rectangular shape, with front and back walls 54, 56, and opposed left and right walls, 58, 60. Housing 52 can further include a lid 62 and a bottom 64, the bottom 64 having one or more feet 65 affixed thereto. Of course, it is understood that primary housing 52 can be any conventional shape. A food chamber 14 can be presented with the housing 52, and the food chamber 14 is preferably elongated laterally to present opposite food chamber ends. It is also within the scope of the present invention where the food chamber 14 has an alternative shape.

The food chamber 14 can be defined at its upper limit by lid 62. Lid 62 can be hinged to, or completely removable from, the primary housing 52, and can include a handle 63. Handle 63 can be made of wood or other none conducting material if desired, to allow safe opening of the lid 62 even when the smoker 10 is hot. At least one, and in one embodiment a plurality, of essentially horizontal food racks 68 (see FIG. 3) can be provided at varying heights within food chamber 14. Food racks 68 can span essentially fully across the interior opening of chamber 14, or any portion thereof, as desired. Food can be positioned on food racks 68 during the smoking, process, as will be described below in detail.

An internal drip tray 66 can be provided to extend across food chamber 14, and preferably can span the entire area beneath the food racks 68, but not entirely close off air circulation from below. The internal drip tray 66 can be selectively removable from food chamber 14 for cleaning or other desired purposes, and can be secured in place by any suitable conventional means. Drip tray 66 includes means to collect liquids dripping from food placed on food racks 68.

Food chamber bottom 190 (see FIG. 4) is provided within primary housing 52, and can include a downward slope of an approximately 2 degree or greater angle from the right smoke chamber 80 towards the left smoke chamber 86. The food chamber bottom 190 can also have the downward slope of an approximately 2 degree or greater angle from the left smoke chamber 86 to the right smoke chamber 80 (e.g., where the smoke generating chamber 28 is positioned adjacent a left end of the smoker 10). In addition to this slope, there can also be a gradual downward slope of food chamber bottom 190 from front smoke chamber 82 toward the center and from back smoke chamber 84 toward the center, creating the lowest portion of food chamber bottom 190 relevantly centered with fan 92. With these slopes, all liquids that may persist within the food chamber 14 are caused to drain towards the outmost left center of the smoker unit 10. At roughly the location of the lower outmost portion of the left center of primary housing 52 can be a drain port (not shown) allowing a fluid communication between the primary housing 52 and external drip pan assembly 70 (see FIG. 3). The drip pan assembly 70 can accept a removable drip pan 72 (this can be the same type of removable pan used for the ash holding bin 44), in which liquids can be collected. The drip pan 72 is held securely in place by the drip pan assembly 70, which also provides means to allow the drip pan 72 to be pulled out from the primary housing 52 to dispose of fluids or other drippings generated during the food smoking process.

The various elements of smoke delivery assembly 16 are in fluid communication with one another, to ultimately deliver the smoke produced in the smoke generator chamber 28 to the food chamber 14, as &scribed below. Smoke delivery assembly 16 can include the smoke generating assembly 12 and the smoke plenum 38. Again, while the smoke generating assembly 12 is preferably positioned outside the food chamber 14 and adjacent one end of the food chamber 14, the smoke generating assembly 12 could be alternatively positioned relative to food chamber 14.

Smoke delivery assembly 16 can further include right smoke chamber 80, front smoke chamber 82, back smoke chamber 84, and left smoke chamber 86 that fluidly communicate with one another. Smoke chambers 80, 82, 84, and 86 can be elongated passageways that fit the outer geometry of food chamber 14 along the interior perimeter of primary housing 52. These smoke chambers can be defined on an outer side thereof by the internal surfaces of primary housing walls 54, 56, 58 and 60, respectively, and can be defined internally by smoke chamber walls 54′, 56′, 58′ and 60′, respectively. The primary housing walls 54, 56, 58 and 60 and smoke chamber walls 54′, 56′, 58′ and 60′ cooperatively form a duct 88 of the smoke delivery assembly 16, with the duct 88 having a pair of parallel duct sections 88a,b (see FIG. 7). In one embodiment, the smoke chambers 80, 82, 84, and 86 can extend horizontally across essentially the full horizontal expanse of the housing walls, and can extend at least partially along the vertical expanse of the walls. In the illustrated embodiment, the duct sections 88a,b each extend about a perimeter of the food chamber 14. Furthermore, the duct sections 88a,b cooperatively extend along the entire perimeter of the food chamber 14 and cooperatively provide a duct passage that extends endlessly about the food chamber 14. However, it is within the ambit of the present invention where the duct sections 88a,b do not extend along the entire perimeter of the food chamber 14.

Because the duct 88 is at least partly formed by the housing walls 54, 56, 58, and 60, the illustrated duct 88 is preferably at least partly outside the food chamber 14. Also, the illustrated duct 88 is preferably exposed to ambient conditions along the path of the duct 88 formed by housing walls 54, 56, 58, and 60. When the temperature of the wood smoke flowing along the exposed portion of the duct 88 is higher than the adjacent ambient air temperature (i.e., the temperature of the air outside the exposed portion of the duct 88), the exposed portion of the duct 88 operates as an air-to-air heat exchanger that transmits heat from the relatively hotter wood smoke to the relatively cooler ambient air. In this manner, the duct 88 is configured to dissipate heat from the controlled flow of wood smoke as the wood smoke travels toward and into the food chamber 14. It will be appreciated that the duct 88 could be alternatively configured to transfer heat from the flow of wood smoke to ambient air or to otherwise dissipate heat from the wood smoke. For instance, the duct 88 could include a larger external surface area (e.g., where the surface area is provided by a multitude of metal fins) to more efficiently transfer heat to ambient air).

While the duct configuration provided by the primary housing walls 54, 56, 58 and 60 and smoke chamber walls 54′, 56′, 58′ and 60′ is preferred to provide a pair of parallel duct paths for heat dissipation, the duct 88 could be alternatively constructed (e.g., to dissipate heat). For instance, the primary housing walls and/or smoke chamber walls could be alternatively shaped (e.g., to provide a single duct path or more than two duct paths). Also, part of, or even all of, the primary housing walls 54, 56, 58 and 60 and smoke chamber walls 54′, 56′, 58′ and 60′ could be replaced with duct structure that is not integral to or integrated with the housing of the smoker 10. For example, the duct 88 could include a duct tubing (not shown) that is positioned exteriorly relative to the smoker 10. Such a duct configuration could be desirable for some smoker embodiments, e.g., where the smoke delivery assembly 16 is provided as an aftermarket addition to a preexisting food cooking enclosure (such as an outdoor barbeque grill).

Smoke delivery assembly 16 can also include an internal fixed or variable speed fan 92 (see FIG. 4), which has as its primary function to pull an air/smoke mixture from the smoke generator 28 into the smoke plenum 38 and through the smoke chambers 80, 82, 84 and 86, and to force the air and smoke mixture into a central smoke diffuser 94 of the duct 88. The fan 92 then forces the air and smoke mixture out ports 104, which ultimately lead into food chamber 14. In doing so, the fan 92 preferably provides a controlled flow of wood smoke through the duct 88 and into the food chamber 14.

In one embodiment, fan 92 can be positioned on the opposed side of the smoker housing 52 from the smoke generator housing 20, to ensure that the smoke is drawn fully through the smoker 10 and ultimately into the food chamber 14 in a controlled, even manner. Furthermore, the illustrated fan 92 is preferably positioned within the duct 88 adjacent an inlet opening of the central smoke diffuser 94. However, it is within the scope of the present invention where the fan 92 is alternatively positioned relative to the duct 88. For instance, the fan 92 could be located upstream of the illustrated position, e.g., where the fan 92 is located within or adjacent to the plenum 38 to push smoke through the smoke chambers 80, 82, 84, and 86 and along the path of the duct 88. Yet further, it is within the ambit of the present invention where the smoke delivery assembly 16 includes multiple fans positioned along the length of the duct 88 (e.g., to suitably move wood smoke along the duct path). Fan 92 can be of any conventional and suitable type known, and can be a single speed or a variable speed fan. External fan motor 92 can be positioned outside of primary housing 52. Fan motor shaft can protrude through primary housing 52 and left smoke chamber inner panel 58′ where fan blade 192 pitch can be positioned in mid plane of left smoke chamber inner panel 58′. A fan housing 98 can be provided to protect fan 92 from rain or other external forces.

In one embodiment, central smoke diffuser 94 can be an elongated passage or channel which extends from the inner left smoke chamber panel 58′ to inner right smoke chamber panel 60′, matching the angled contour of food chamber bottom, creating a sealed chamber. Diffuser 94 can be positioned under drip tray 66, and its front and back walls 100, 102 can be spaced from front and back smoke chamber inner walls 54′, 56′, respectively.

Diffuser 94 can include one or a plurality of small discharge openings 104 in both the front wall 100 and back wall 102 thereof (see FIGS. 3 and 4), through which smoke can leave the diffuser 94 and enter the food chamber 14. Similarly, front and back smoke chambers 82, 84 can include a plurality of small openings 106, both for allowing passage of smoke from the smoke chambers and into the food chamber 14, and for recycling air from the food chamber 14 back into the smoke chambers 82, 84 to mix with the air and smoke within the smoke delivery assembly 16. Openings in diffuser 94, front wall 100, and back wall 102 can be any shape or a combination of shape and sizes. While the illustrated diffuser 94 preferably provides the discharge openings 104, it is within the scope of the present invention where alternative structure forms the discharge openings 104. It will also be appreciated that the diffuser 94 could be variously configured to direct wood smoke. Also, for some aspects of the present invention, the duct 88 could be devoid of diffuser 94.

In one embodiment, internal heating elements 112 (see FIGS. 3, 7, and 8) can be secured to and extend outwardly from diffuser front wall 100 and diffuser back wall 102, and into food chamber 14. Heating elements 112 can preferably be electrical resistance heating elements, and can be of any suitable conventional means employed to provide added heat to smokers or the like. Heating elements 112 can be positioned under drip tray 66 and be positioned inline with diffuser openings 104, allowing the air and smoke mixture provided by the fan to blow across the heating elements 112 for more even heat distribution throughout the food chamber 14. As will be discussed in more detail below, the heating elements 112 can be selectively employed to increase the temperature of the air and smoke circulating throughout the food chamber 14, primarily adding heat to smoke and air mixture exiting the central smoke diffuser at openings 104 as it enters food chamber 14.

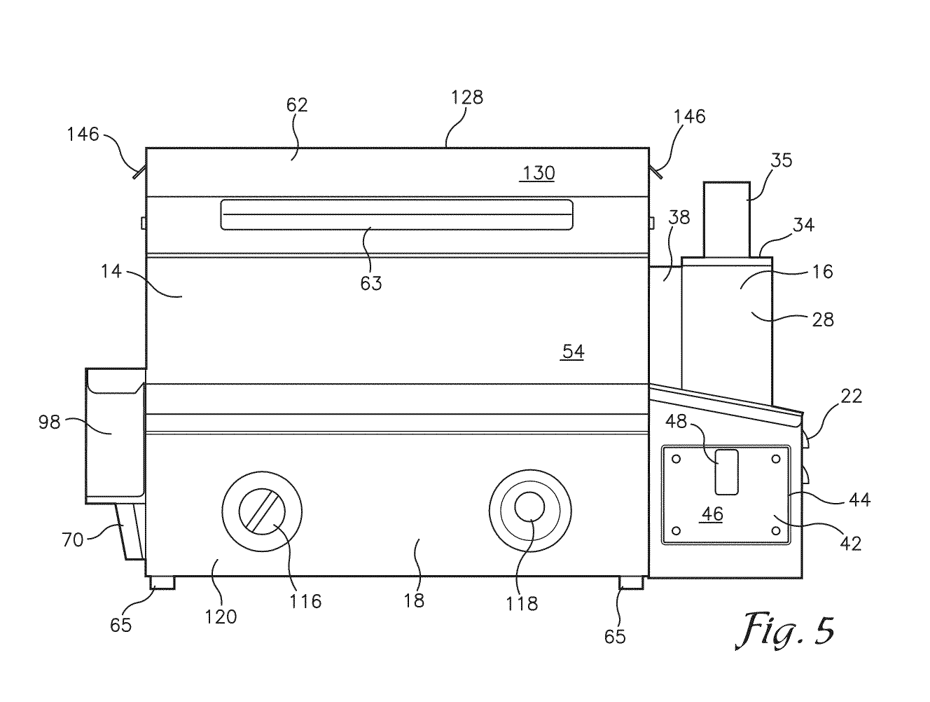

The control panel 18 can include a timer for activating the external smoker heating element 36 fan 92, and optionally, also activating the internal heating element 112 if desired (see FIG. 5). In one embodiment, the timer 116 is a 60-minute timer. Other time ranges can also be provided, and are within the scope of the present invention. The control panel 114 can also include a temperature controller 118, which is used to activate the internal heating element 112 when so desired. In one embodiment, the temperature controller 118 can be set at temperatures ranging from “OFF” (wherein no added heat is provided, and the ambient or cool temperature is maintained in the food chamber 14, subject to any heat introduced by the smoke and air mixture entering the food chamber 14) to 350° F., and preferably its upper temperature range can be 225° F. to 275° F. More preferably, its upper temperature can be 250° F. Thus, the heating elements 36,112 can preferably be powered independently of one another. This permits the internal heating elements 112 to be turned off while the external smoker heating element 36 is turned on to produce wood smoke. The timer 116 and temperature controller 118 are operably coupled to heating element 36 and heating elements 112, respectively, to control the heating element 36 independently of heating elements 112, and vice versa. It will be understood that the temperature controller 118 and the control timer 116 can each comprise a mechanical and/or electrical control device. Control panel 114 can be provided on a lower portion 120 of front housing wall 54. As depicted in the drawings, lower portion 120 can preferably flare sufficiently outwardly from food chamber 14, wherein the control panel 114 is positioned as a separate panel to eliminate contact with any drippings from the food chamber 14.

Lid 62 can include a substantially planar top 128, framed by front and back sides 130, 132, and left and right sides 134, 136. In one embodiment, lid 62 can be hingedly connected to back housing wall 56 by any conventional means which allow lid 62 to open from primary housing 52 to allow access to food chamber 14, while remaining at least partially secured to primary housing 52. For example, the hinge connection can be a piano hinge or a pin and bearing pivot. In the embodiment depicted in the drawings, couplings 138 are provided in a back portion of left and right sides 132, 134, and hingedly couple sides 132, 134 with a back and upper portion of left and right housing walls 58, 60 respectively. Any conventional means for providing a hinged connection may be utilized. In another embodiment, lid 62 can be fully removable (not depicted). At least one handle 140 can be provided on the lid 62, and can preferably be made of a material that does not conduct heat, such as wood or the like, which allows for lid 62 to be opened without the need to utilize protective gloves or the like.

Air vents 142 (FIGS. 3 and 4) can be provided on at least the left and right sides 134, 136 of lid 62, to allow some smoke from the food chamber 14 to be vented outward, if desired. In one embodiment, air vents 142 can be adjustable, in order to increase or decrease the amount of smoke in the food chamber 14. An air flow indicator 144, located just below each air vent 128, can be utilized to mechanically adjust the air vents 128 to the desired degree of openness, ranging from fully opened to fully closed. Rain guards 146 can be provided above air vents 142, and can include an elongated strip of material either included in the top planer surface of lid 62 or affixed to left and right lid sides 134, 136, just above air vents 142, and extending outwardly at a downward slope to direct rain or other unwanted elements away from air vents 142. In one embodiment, no air vents are provided.

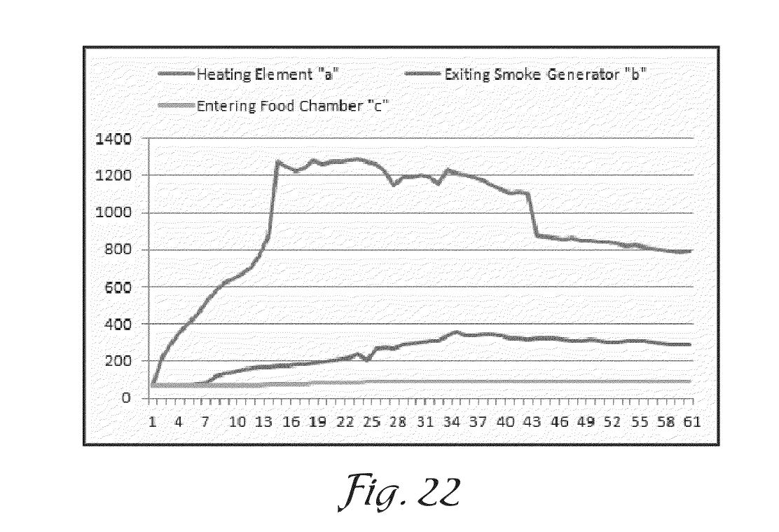

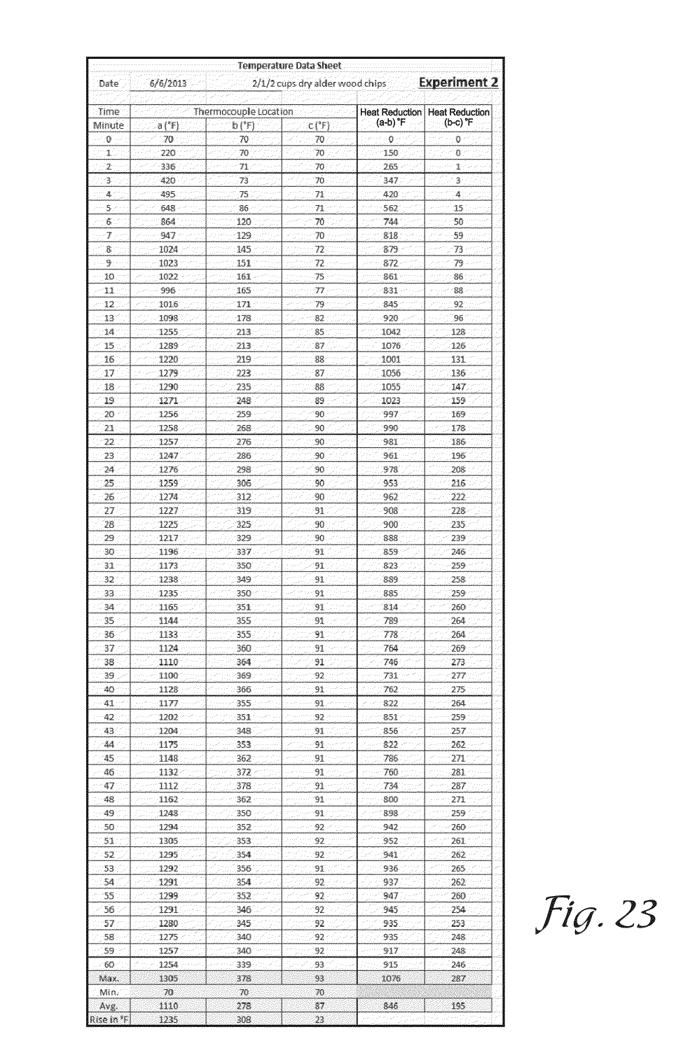

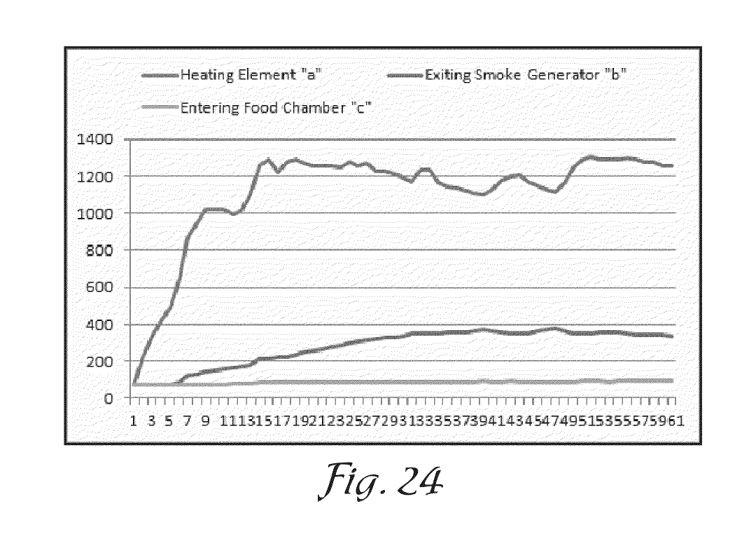

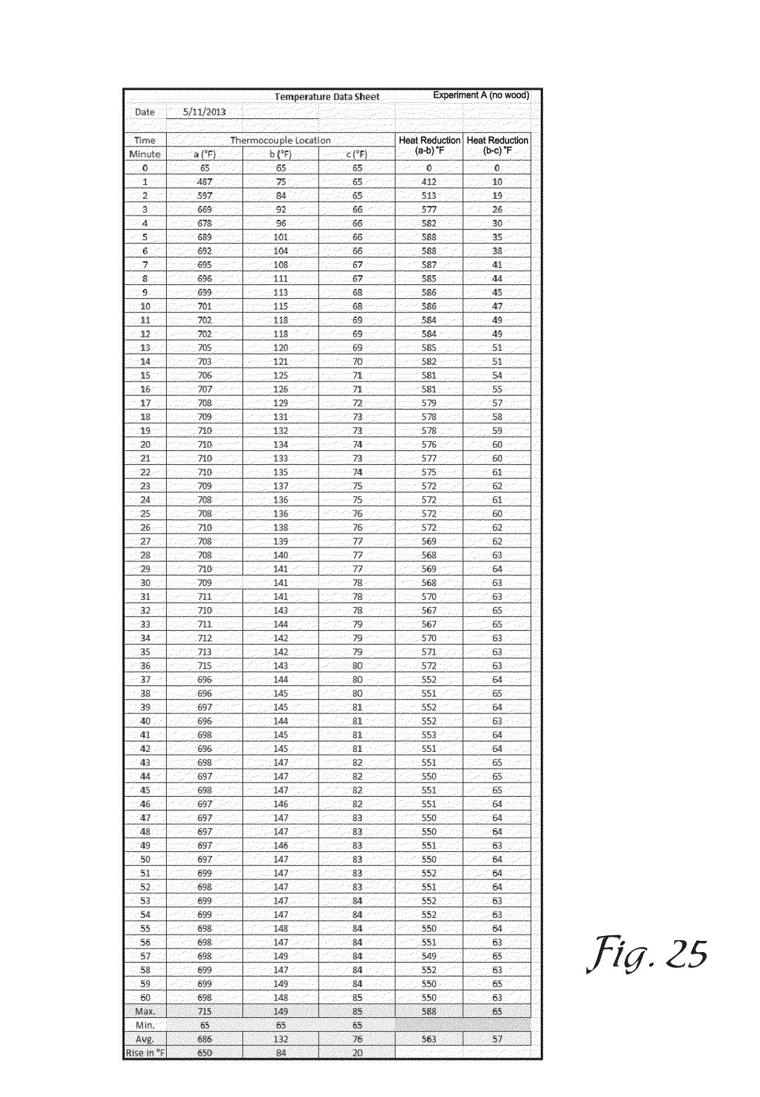

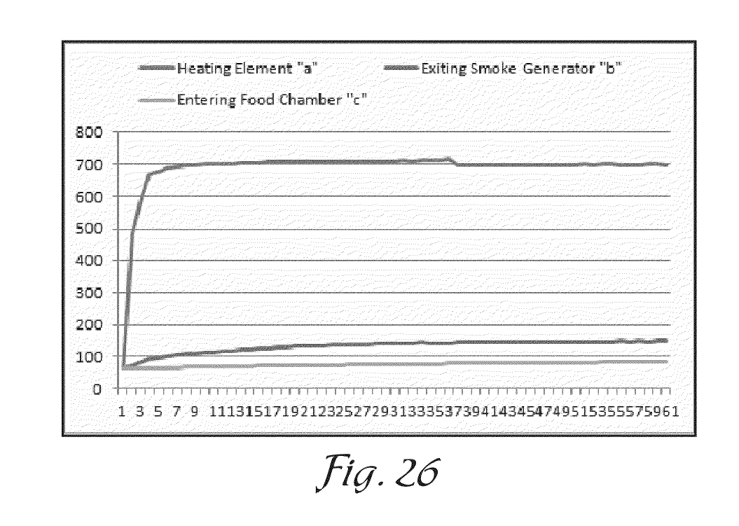

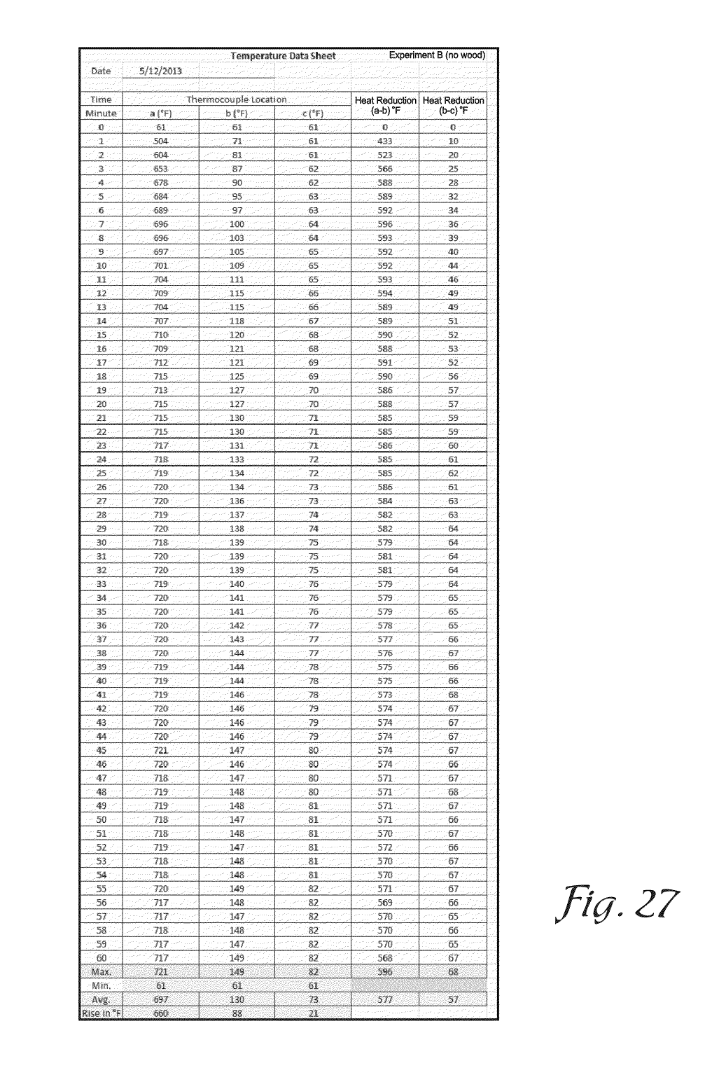

In one embodiment, the external smoker heating element 36 can be positioned in the lower end portion 33 of smoke generator chamber 28, and can be a low wattage electrical resistance heating element which is designed to heat wood hot enough to char or smolder, but not hot enough to burn the wood. As depicted in FIGS. 13-20, the element 36 can include an insulator 148 comprised of an essentially rectangular base 150 having an elongated support 152 extending there from in an essentially perpendicular direction. Insulator 148 can be any nonconducting material, and in one embodiment can be alumina ceramic or other high temp insulating material, and can serve both to insulate against the electrical conductivity and thermal transmission. Preferably, the heating element comprises a resistance heating wire (not shown), with the support 152 being adapted to receive the wire. Resistance wire can be of any suitable material, and in one embodiment is nichrome wire. More preferably, the resistance wire comprises nichrome wire that preferably ranges from about thirty-four gauge (34 ga) to about twenty-six gauge (26 ga) and, more preferably, is about twenty-eight gauge (28 ga). The resistance wire presents a wire length that preferably ranges from about thirty inches (30″) to about thirty-nine inches (39″) and, more preferably, is about thirty-six inches (36″). Furthermore, when powered by twenty-four volts (24 V) of electricity, the resistance wire emits energy that preferably ranges from about thirty-four watts (34 W) to about forty-five watts (45 W) and, more preferably, is about thirty-eight watts (38 W). However, it is within the ambit of the present invention where the wire is alternatively configured (e.g., the wire could include an alternative material, length, and/or gauge) In one embodiment, element 36 can be positioned in smoke generator chamber 28 adjacent an aperture in back smoke chamber wall 31 (see FIG. 3), whereby base can remain outside chamber 28, and only the heating portion of the element 36, namely support 152 having resistance wire wrapped therearound, extends within chamber 28. Base 150 can be adapted to have means for mounting on the exterior surface of back chamber wall 31, using any suitable conventional mounting means. Support 152 and resistance wire can be adapted to have direct contact with a wood source within smoke generator chamber 28, as discussed below. Resistance wire can be supplied, with 120VAC or voltage can be supplied by a reduced voltage transformer, preferably 24-48 VAC.

In one embodiment of the present invention, elongated support 152 can have a thin, bow tie or essentially rectangular shape, with sides 156 having a height h at least 3 times larger than the width w of support top 158 and support bottom 160. Preferably, height h can be 3.5 to 5 times larger than width w. In one embodiment, width w can be 2 to 4 mm, and preferably can be 2.1 to 3 mm. Support top and bottom 158, 160 can each include a series of notches 162, preferably cut at a sufficient pitch to direct resistance wire therearound in a helical path 154. For example, resistance wire can be directed around support 152 by notches 162 such that the pitch can be 0.09 inches to 0.22 inches, and preferably can be 0.120 inches, and the wire can make 10 to 27 revolutions, and preferably can make 19 revolutions, around support 152.

Support base 150 can have a series of apertures extending therethrough. Apertures 166a, b can be designed to accept mounting means such as screws or the like, whereby support base 152 of insulator 148 can be selectively secured to back chamber wall 31. The heating element 36 can be positioned on any wall of the smoke generator chamber 28. Apertures 168a, b are configured to accept electrical terminal connections therein, and apertures 170a, b are designed to accept wire therethrough, wherein an electrical connection is achieved by passing resistance wire through apertures 170a, b, and then bringing resistance wire into contact with the electrical connections presented adjacent apertures 168a, b.

In one embodiment, external heating element, by itself, can produce temperatures of up to 600° F. to 850° F., and preferably can reach temperatures of 650° F. to 750° F. The thin design of support 152 can allow ash formed by the charring or smoldering of the wood source to easily fall from the heating element 36 onto wood/ash receiving base 180 by means of gravity. As ash forms and subsequently separates and falls downwardly from the wood, the heating element 36 can then come into contact with the un-charred portion of the wood source, facilitating the smoking process. Under normal operation, chips can be disturbed with the use of the supplied nonconducting stir stick 27 or equivalent at sonic point during the operational time, as desired by the by user, by removing smoke generator chamber lid 34 and stirring chips. Using the external heating element 36 of the present invention, the smoke for the smoking process can be generated outside of the food chamber 14, using temperatures just high enough to char the wood source, such as wood chips or the like. The temperature of the smoke is then necessarily cooled as it is pulled by the fan 92 and flows through the internal smoke chambers 80, 82, 84, 86, before it is ultimately diffused into the food chamber 14 by means of the central smoke diffuser 94. The food chamber 14 temperatures can be as low as ambient temperature, and can range up to the temperature selected by the temperature controller 118, as heat can be selectively introduced into the smoke by internal heating element 112, if desired. Because the smoke is generated in the smoke generator housing 20 outside of and separate from the food chamber 14, and because the smoke travels through the path provided by the smoke delivery assembly 16, the smoker 10 of the present invention can produce an ambient or cold smoke environment, or a warm smoke environment, as desired.

In operation of one embodiment, the smoke generator chamber 28 can be filled with a wood source such as wood chips or the like (not shown), which are introduced into smoke generator chamber 28 by removing or opening smoke chamber lid 34 and exposing the internal portion of chamber 28. The wood chips or the like can be introduced with or without using funnel 26. Lid 62 of the smoker primary housing 52 can be opened using handle 63, exposing food chamber 14. Food can then be placed into the food chamber 14, and lid 62 can then be closed. The desired food chamber 14 temperature can be selected by using the temperature controller 118. As noted above, in one embodiment this temperature can range from “Off”, or ambient or cool temperature, to the upper temperature range indicated previously. The timer 116 can then be activated to the desired smoking or marinade time. The low wattage heating element 36 can be activated by the timer 116, producing a temperature high enough to char but not burn the wood source. The internal heating element 112 can also be activated when desired, and is activated by the timer 116 controller.

When the timer 116 is activated, the external fan 92 can also be activated, pulling air and smoke from the smoke generator chamber 28 through the smoke plenum 38, and into the right smoke chamber 80. The air and smoke mixture can then continue to flow into the front and back smoke chambers 82, 84 respectively, where it can be mixed with a portion of internal air from smoke chamber openings 106, allowing some internal air to re-circulate. The air and smoke mixture can then enter the left smoke chamber 86 where the fan 92 directs the smoke into the central smoke diffuser 94. The smoke and air mixture can then be dispersed evenly through diffuser openings 104 and across the internal heating element 112 to evenly disperse the smoke and circulate the added heat from the internal heating element 112 (if desired) throughout the food chamber 14, allowing the food to be rapidly and evenly infused with smoke.

The air and smoke path of the smoke delivery system not only achieves essentially even distribution of smoke throughout the food chamber 14, but can also function to cool the smoke before it enters the food chamber 14, so that the food can be infused with smoke without utilizing temperatures which could cause the food being smoked to cook or melt.

When the timer 116 shuts down, the smoke generating assembly 12 can also be caused to shut down, with external heating element 36, fan 92, and internal heating element 112 (if used) all turning off. The smoking cycle is then complete.

A series of experiments were conducted, whereby the temperatures were measured at various points through the smoke delivery path, when the smoker 10 was operated in the manner discussed above. The results emphasize that producing the smoke in a smoke generator chamber 28 located outside of the primary housing 52 which houses the food chamber 14, can allow the smoke to cool to ambient, or essentially ambient temperature, or to cool smoking temperature, prior to entering food chamber 14. Thus, food can be smoked without being cooked, including for cheese or the like, meats or other foods for which pre-smoking is desired before cooking.

In two such experiments, using the operation of the smoker 10 essentially as discussed in detail above, data is provided as shown on charts entitled Experiment 1 and Experiment 2 (see FIGS. 21-24), and that data is summarized in the Experiment Summary chart in Table below. In both experiments, the temperature was recorded by a thermocouple at three different locations, Points A, B and C (see FIG. 3). Point A is the middle of external heating element 36. Point B is the smoke temperature adjacent air flow portals 40, where the smoke exits smoke generator chamber 28 to enter smoke plenum 38. Point C is the smoke temperature adjacent diffuser openings 104 where the smoke exits the central smoke diffuser 94 of the smoke delivery assembly 16 and enters food chamber 14. A wood source was provided in the smoke generator chamber, and the timer was activated to 60 minutes, which in turn activated both the external heating element 36 and the external fan 92. The internal heating element 112 was not activated, and remained in the “off” position. The wood chips were not disturbed during the experiments. The temperature was measured and recorded at each of Points A, B and C every minute for 60 minutes, beginning from just prior to activating the timer 116 and external heating element 36, denoted as minute 0. The maximum and minimum temperatures were noted, and the average temperatures and rise in temperatures were calculated, as were the reductions in heat as measured along the smoke delivery path.

TABLE 1

| Time | Thermocouple Location | | | Heat Reduction | Heat Reduction | |
|---|---|---|---|---|---|---|
| Minute | a (° F.) | b (° F.) | c (° F.) | (a − b)° F. | (b − c)° F. | 2½ Cups Wood Chips |
| Max. | 1291 | 361 | 91 | 1099 | 270 | Experiment 1 |
| Min. | 67 | 67 | 67 | | | |
| Avg. | 937 | 245 | 84 | 704 | 164 | |
| Rise in ° F. | 1224 | 294 | 24 | | | |
| Max. | 1305 | 378 | 93 | 1076 | 287 | Experiment 2 |
| Min. | 70 | 70 | 70 | | | |
| Avg. | 1110 | 278 | 87 | 846 | 195 | |
| Rise in ° F. | 1235 | 308 | 23 | | | |

In Experiment 1, the temperature recorded at Point A ranged from 67° F. at minute 0, to 1291° F. at minute 23, and averaged 937° F. Moving to point B, the temperature of the smoke and air mixture exiting generating chamber 28 and entering the smoke plenum 38 through air flow portals 40 ranged from 67° F. at minute 0 to 361° F. at minute 34, averaging 245° F. Finally, the temperature of the smoke and air mixture was measured at Point C as it exited the central smoke diffuser 94 through diffuser openings 104 and entered the food chamber 14, again ranging from 67° F. at minute 0 to a maximum of 91° F. at minute 29, and reaching the maximum at multiple points later, averaging 84° F. An analysis of this data shows measurement point A beginning at ambient temperature and raising to between 298° F. and 352° F. within 3 minutes, at which time the smoke generating assembly began to dispense smoke into the smoke delivery assembly 16, to temperatures primarily averaging 937° F., before leaving the smoke generating chamber 28. However, by the time the smoke and air mixture traveled through the smoke delivery assembly 16 as directed by the external fan 92, and entered the food chamber 14, it had cooled to well within the ambient temperature or cool smoking temperature range, which is typically understood by those in the industry to refer to temperatures at or under 100° F. Here, the smoke entering the food chamber never rose above 91° F., averaging 84° F., which was relatively only slightly above the beginning ambient temperature associated with the conditions of Experiment 1, and remained well within the cool smoking temperature during the entire duration. During the 60 minute duration of Experiment 1, an average of 73.8% or 692° F. of the heat generated at point A by external heating element 36 was not transferred to the smoke at Point B. There was a further average continual reduction in heat, from Point B to Point C, of 161° F. or 65.7%, due to the ported smoke and air flow through the various smoke chambers and smoke diffuser of the smoke delivery assembly 16.

In Experiment 2, the temperature recorded at Point A ranged from 70° F. at minute 0, to 1305° F. at minute 51, and averaged 1110° F. Moving to point B, the temperature of the smoke and air mixture exiting generating chamber 28 and entering the smoke plenum 38 through air flow portals 40 ranged from 70° F. at minute 0 to 378° F. at minute 47, averaging 278° F. Finally, the temperature of the smoke and air mixture was measured at Point C as it exited the central smoke diffuser 94 through diffuser openings 104 and entered the food chamber 14, again ranging from 70° F. at minute 0 to a maximum of 93° F. at minute 60, averaging 87° F. An analysis of this data shows measurement point A beginning at ambient temperature and raising quickly (between minute 2 and 3) to temperatures primarily ranging to between 336° F. and 420° F. at which time the smoke generating assembly began to dispense smoke into the food chamber, and to a max of 1305° F. before leaving the smoke generating chamber 28. However, by the time the smoke and air mixture traveled from the external heating element 36 and entered the food chamber 14, it had cooled to an average of 87° F., well within the ambient temperature or cool smoking temperature range. In Experiment 2, the smoke entering the food chamber 14 never rose above 93° F., with the 87° F. average being only relatively slightly above the beginning ambient temperature associated with the conditions of Experiment 2, and it remained well within the cool smoking temperature for the duration of the experiment. During the 60 minute duration of Experiment 2, an average of 75% or 832° F. of the heat generated at point A by external heating element 36 was not transferred to the smoke at Point B. There was a further average continual reduction in heat, from Point B to Point C, of 195° F., or a reduction of temperature of about 68.7% due to the air flow through the various smoke chambers and smoke diffuser of the smoke delivery assembly 16.

In two other experiments, the smoker 10 was operated without the use of wood chips or chunks in the smoke generating assembly 12. Using the operation of the smoker 10 essentially as discussed above, data is provided as shown on charts entitled Experiment A and Experiment B (see FIGS. 25-28), and that data is summarized in the Experiment Summary chart in Table 2 below.

TABLE 2

| Time | Thermocouple Location | | | Heat Reduction | Heat Reduction | |
|---|---|---|---|---|---|---|
| Minute | a (° F.) | b (° F.) | c (° F.) | (a − b)° F. | (b − c)° F. | Data using No Wood |
| Max. | 715 | 149 | 85 | 588 | 65 | Experiment A |
| Min. | 65 | 65 | 65 | | | |
| Avg. | 686 | 132 | 76 | 583 | 57 | |
| Rise in ° F. | 650 | 84 | 20 | | | |
| Max. | 721 | 149 | 82 | 566 | 68 | Experiment B |
| Min. | 61 | 61 | 61 | | | |
| Avg. | 697 | 130 | 73 | 577 | 57 | |
| Rise in ° F. | 660 | 88 | 21 | | | |

During operation, and as noted above, ashes created by the charring of the wood on heating element 36 are contained within smoke generating chamber 28 and wood/ash receiving base 180. Such ashes fall by means of gravity into the ash holding bin 44 after the ash receiving assembly 42 is pulled to the open position. As described above, the ash holding bin 44 is selectively removable from the smoke generator housing 20 using handle 48, and can be selectively removed from housing 20 to allow for easy disposal of the ash. Handle 48 on the ash holding bin 44 can be a nonconductive material such as wood or the like, which can allow for the ash to be safely removed from the smoke generating assembly 12 and emptied even while the device is still hot, if desired.

Condensate liquids that can emerge inside the food chamber 14 and internal panels of the smoke chambers flow by gravity and are channeled by the angled portion of the food chamber bottom 190 (discussed previously). The liquids flow from the food chamber bottom 190 into the drip receiving pan 72, which, as noted above can be removable for easy disposal.

As noted above, the smoke generating assembly 12 of the present invention can produce a consistent smoke volume separate from and independent of the food chamber 14 temperature, and thus the smoker 10 can selectively create an actual ambient temperature or cool smoke temperature environment, or alternatively a warm smoke environment. The intense smoke produced within the smoker 10 can able to infuse foods in as little as ten minutes or quicker, depending on personal tastes. Importantly, foods of all types can be marinated in natural wood smoke using this ambient temperature or cool temperature smoker apparatus 10, including foods such as cheese, as the smoker 10 of the present invention can allow foods to marinate quickly with a natural smoke flavor, without actually cooking the product. The smoke infused food product or products can then be prepared on conventional cooking methods such as a grill, oven, skillet or the like, or can be packaged for later consumption without loss of flavor.

It is contemplated and within the scope of the present invention that the external smoke generating assembly 12 and/or smoke delivery assembly 16, in part or whole, of the present invention can be configured as an aftermarket addition to existing smokers, grills or the like, to provide a presmoking or ambient/cool smoking option to existing equipment.

Although the above description presents features of preferred embodiments of the present invention, other preferred embodiments may also be created in keeping with the principles of the invention. Such other preferred embodiments may, for instance, be provided with features drawn from one or more of the embodiments described above. Yet further, such other preferred embodiments may include features from multiple embodiments described above, particularly where such features are compatible for use together despite having been presented independently as part of separate embodiments in the above description.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

What is claimed is:

1. A cool temperature smoker operable to marinate food in natural smoke, said cool temperature smoker comprising:
a housing that defines a food chamber to receive the food during smoking;
an external smoke box that produces wood smoke at a temperature above ambient temperature, with the smoke box being positioned outside the food chamber;
a duct that extends between and fluidly connects the smoke box and the food chamber to one another along a duct path, with the duct being operable to fluidly transmit wood smoke along the duct path; and
a fan positioned in fluid communication with the duct and operable to provide a controlled flow of wood smoke through the duct,
said duct extending at least partly outside the food chamber and configured to be exposed to ambient conditions along the duct path to dissipate heat from the controlled flow of wood smoke as the wood smoke travels toward and into the food chamber.

2. The cool temperature smoker as claimed in claim 1,
said food chamber and said smoke box defining a minimum distance therebetween,
said duct path defining a path distance longer than the minimum distance.

3. The cool temperature smoker as claimed in claim 2,
said food chamber defining a perimeter, with the duet extending at least partly along the perimeter of the food chamber.

4. The cool temperature smoker as claimed in claim 3,
said duct extending along the entire perimeter of the food chamber.

5. The cool temperature smoker as claimed in claim 2,
said food chamber presenting opposite chamber ends,
said smoke box being positioned adjacent one of the chamber ends,
said duct presenting a duct discharge opening that fluidly directs the wood smoke out of the duct,
said duct discharge opening being positioned between the chamber ends, with the duct extending about the food chamber.

6. The cool temperature smoker as claimed in claim 5,
said duct including opposite duct sections that extend laterally between the chamber ends, with the duct sections extending about opposite sides of the food chamber.

7. The cool temperature smoker as claimed in claim 5,
said fan being positioned adjacent the duct discharge opening and operable to draw wood smoke toward the duct discharge opening.

8. The cool temperature smoker as claimed in claim 1,
said smoke box including a housing and a smoke box heating element,
said housing presenting a smoke chamber that receives the heating element.

9. The cool temperature smoker as claimed in claim 8,
said heating element being operable to produce a maximum heating temperature that ranges from about 600° F. to about 850° F.

10. The cool temperature smoker as claimed in claim 8,
said heating element including a 28 gauge nichrome electrical resistance wire.

11. The cool temperature smoker as claimed in claim 10,
said heating element including an elongated insulator that supports the wire,
said insulator extending laterally through the smoke chamber to present a length dimension.

12. The cool temperature smoker as claimed in claim 11,
said insulator presenting a width dimension measured laterally and transverse to the length dimension, with the width dimension being shorter than the length dimension.

13. The cool temperature smoker as claimed in claim 12,
said width dimension ranging between about two millimeters to about four millimeters.

14. The cool temperature smoker as claimed in claim 8; and
an internal heating element positioned within the food chamber to selectively heat the food.

15. The cool temperature smoker as claimed in claim 14,
said heating elements being powered independently of one another, with the internal heating element configured to be turned off while the smoke box heating element is turned on to produce wood smoke.

16. The cool temperature smoker as claimed in claim 15; and
a control panel including a pair of controls,
each of said controls being operably coupled to a respective one of the heating elements so that each heating element is controllable independently of the other heating element.

17. The cool temperature smoker as claimed in claim 1,
said duct including a smoke diffuser positioned within the housing,
said smoke diffuser defining a duct discharge opening that fluidly directs the wood smoke out of the duct.

18. The cool temperature smoker as claimed in claim 17,
said food chamber being elongated and presenting opposite chamber ends,
said smoke diffuser extending along the length of the food chamber, with the duct discharge opening located longitudinally between the chamber ends.

19. The cool temperature smoker as claimed in claim 18; and
an internal heating element positioned within the food chamber to selectively heat the food, with the internal heating element extending adjacent the duct discharge opening.

20. A smoke delivery assembly operably connectable to a cooking enclosure to marinate food in natural smoke, with the cooking enclosure defining a food chamber to receive the food during smoking, said smoke delivery assembly comprising:
an external smoke box that produces wood smoke at a temperature above ambient temperature, with the smoke box operable to be positioned outside the food chamber;
a duct fluidly connected to the smoke box and operable to extend between and fluidly connect the smoke box and the food chamber to one another along a duct path, with the duct being operable to fluidly transmit wood smoke along the duct path; and
a fan positioned in fluid communication with the duct and operable to provide a controlled flow of wood smoke through the duct,
said duct operable to extend at least partly outside the food chamber and to be exposed to ambient conditions along the duct path to dissipate heat from the controlled flow of wood smoke as the wood smoke travels toward and into the food chamber.

21. The smoke delivery assembly as claimed in claim 20,
said duct being elongated to extend at least partly along the perimeter of the food chamber.

22. The smoke delivery assembly as claimed in claim 21,
said duct presenting a duct discharge opening that fluidly directs the wood smoke out of the duct, with the duct discharge opening being positionable between ends of the food chamber.

23. The smoke delivery assembly as claimed in claim 22,
said duct including opposite duct sections configured to extend laterally between the chamber ends.

24. The smoke delivery assembly as claimed in claim 22,
said fan being positioned adjacent the duct discharge opening and operable to draw wood smoke toward the duct discharge opening.

25. The smoke delivery assembly as claimed in claim 20,
said smoke box including a housing and a smoke box heating element,
said housing presenting a smoke chamber that receives the heating element.

26. The smoke delivery assembly as claimed in claim 25,
said heating element being operable to produce a maximum heating temperature that ranges from about 600° F. to about 850° F.

27. The smoke delivery assembly as claimed in claim 25,
said heating element including a 28 gauge nichrome electrical resistance wire.

28. The smoke delivery assembly as claimed in claim 27,
said heating element including an elongated insulator that supports the wire,
said insulator extending laterally through the smoke chamber to present a length dimension.

29. The smoke delivery assembly as claimed in claim 28,
said insulator presenting a width dimension measured laterally and transverse to the length dimension, with the width dimension being shorter than the length dimension.

30. The smoke delivery assembly as claimed in claim 29,
said width dimension ranging between about two millimeters to about four millimeters.

31. The smoke delivery assembly as claimed in claim 20,
said duct including a smoke diffuser positioned within the housing,
said smoke diffuser defining a duct discharge opening that fluidly directs the wood smoke out of the duct.
